(19) United States
(12) Patent Application Publication
(10) Pub. No.: US 2018/0156633 A1
(43) Pub. Date: Jun. 7, 2018

(54) SYSTEM AND METHOD FOR VERTICAL FLIGHT DISPLAY

(71) Applicant: Sandel Avionics, Inc., Vista, CA (US)

(72) Inventors: Delmar M. Fadden, Preston, WA (US); Gerald J. Block, Vista, CA (US); Richard W. Taylor, Seattle, WA (US)

(21) Appl. No.: 15/579,525

(22) PCT Filed: Jun. 6, 2016
(86) PCT No.: PCT/US2016/036088

§ 371 Date: Dec. 4, 2017

Related U.S. Application Data
(60) Provisional application No. 62/171,021, filed on Jun. 4, 2015.

(51) Int. Cl. G01C 23/00; B64D 43/02; G01C 21/20; G05D 1/08; G05D 1/04

(52) U.S. Cl. CPC G01C 23/005; B64D 43/02; G05D 1/042; G05D 1/0808; G01C 21/20

(57) ABSTRACT

Systems and methods for a vertical flight display are disclosed. The vertical flight display consolidates information about the vertical controls and situation of an airplane for ease of use by the pilot. The vertical flight display may display a flight path plan, a flight path angle, and a potential flight path angle. The potential flight path angle may be employed to assist the pilot in total energy management. The vertical flight display may also display situation data, including altitude and vertical speed, and predictive data, including the consequences of the current control action. The predictive data is calculated by inertially quickening the result of control changes. The vertical flight display enables a pilot to quickly see the results of the control changes in order to coordinate pitch and power.

### CROSS-REFERENCE TO RELATED APPLICATIONS

This application claims benefit of priority of U.S. Provisional Patent Application Ser. No. 62/171,021, filed Jun. 4, 2016, entitled “SYSTEM AND METHOD FOR VERTICAL FLIGHT DISPLAY”, owned by the assignee of the present application and herein incorporated by reference in its entirety.

### FIELD OF THE INVENTION

The field of the invention relates to avionics instrumentation, and more particularly to avionics instrumentation involving vertical flight information.

### BACKGROUND OF THE INVENTION

Efficient management of an airplane vertical flight path involves precise and timely control of both airplane pitch attitude and power. Such is particularly true of vertical flight information, where errors are measured in tens of feet, in contrast to horizontal or lateral situations, in which there is significantly more room for error. Information suitable for manual control of these two parameters previously has been displayed on different instruments and with different dynamic characteristics, thus requiring pilots to review multiple instruments if certain types of transitions are desired, e.g., constant speed ascents or descents, etc.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

Integrating all of the information listed above in a single instrument has not been feasible previously due to, among many other reasons, lack of computing bandwidth and, for many airplanes, a lack of adequate sensors, e.g., inertial sensing equipment, as well as ways to integrate such sensor information.

In addition, prior to the availability of Performance Based Navigation (PBN), there was little incentive to incorporate a specific vertical path in airplane flight plans except for constant altitude legs and the final approach segment. Here it is noted that Performance Based Navigation (PBN) is generally any means of defining the airplane position over the surface of the earth with a quantified real-time certainty. This capability is fundamental to ICAO plans for higher capacity air traffic around the world. The FAA uses the PBN concept as the basis for the US next generation air traffic control system. The increasing use of PBN makes precision vertical path navigation, including, e.g., descents, important for managing traffic in high density regions.

Visualizing such vertical paths has been limited to traditional deviation displays and in a few airplane types, a vertical situation display (VSD). Such displays are intended to provide a “big picture” overview of the intended path, but rely on autopilot or flight director to achieve the required path tracking precision.

Systems and methods according to present principles provide a vertical flight display (VFD) with sufficient path sensitivity and trend information for the pilot to control the airplane directly by reference to the display, while achieving the required path precision, regardless of the speed of the airplane. Since the display supports precision manual flight, it can provide a significantly enhanced means of monitoring automatic flight as well. The systems and methods can thus interface with an autopilot or flight director to control the airplane or provide commands to a pilot.

Systems and methods according to present principles also provide a path defined system which may be employed, e.g., in the ICAO/FAA NextGen air traffic system where a fully defined path is the norm.

In so doing, the systems and methods according to present principles provide a vertical flight display that incorporates sensitive situation data with respect to the airplane proximity to the desired vertical path along with predictive data showing the consequences of a current control action, these aspects incorporated into a single display, allowing the pilot to precisely coordinate pitch and power and to observe immediately the effect that a control change will have on the vertical flight path and total energy state.

Because the horizontal and vertical scaling necessary to support path control are inconsistent with the scaling desired to give the pilot a longer term overview of the developing vertical situation, the VFD may be augmented with a companion vertical situation display (VSD). A rectangular area within the VSD may be employed to show the pilot the region displayed within the VFD.

Systems and methods according to present principles further provide a way to visualize flight path angle and flight plan path on the VFD. Such displays are generally unavailable on most airplane. The systems and methods according to present principles in a further implementation also include a way to visualize a potential flight path angle which can be advantageously employed as an energy management tool. The data within the potential flight path angle can be employed to help the pilot understand what the total energy situation is, and to act accordingly. For example, if the potential flight path angle is embodied by an acceleration symbol that is displayed as bracketing the flight path angle, then the pilot has the right amount of thrust to hold the present airplane speed and the present flight path angle as is. If the acceleration symbol is displayed above the current flight path angle, then the pilot knows that energy is being added and the airplane will climb or accelerate or perform a mix of both. Similarly, if the acceleration symbol is below the flight path angle, then there is not enough energy to maintain the current situation, and the airplane will either decelerate, descend, or both.

In one aspect, the invention is directed towards a method for displaying vertical flight information, including: receiving first flight data about an airplane, including vertical flight data; and displaying an indication of the vertical flight data on a display, where a range of the displayed data is configured to represent a look ahead duration in time, the range extending over an expected distance the airplane will travel in the duration in time; receiving second flight data about the airplane; updating the displayed indication of the vertical flight data on the display, the updating such that the look ahead duration in time is maintained at a constant value.

Implementations of the invention may include one or more of the following.

The first flight data and the second flight data may include ground speed, vertical speed, and proximity to the ground. The first flight data and the second flight data may further include one or more selected from the group consisting of: vertical flight plan, current altitude, current vertical speed, current longitudinal acceleration, current vertical acceleration, terrain profile beneath flight plan, target altitude value, runway elevation, and a minimum altitude for the current instrument approach procedure. The displaying may be performed with sufficient sensitivity such that a pilot is enabled to control the vertical flight of an airplane with the displayed data. The displaying may be such that direct manipulation of the pitch and power controls is supported. The duration may be selected from the group consisting of: 30 seconds, one minute, one and a half minutes, or three minutes. The method may further include displaying a flight path angle on the display, the flight path angle based on quickened vertical speed and ground speed. The method may further include displaying an indication of a potential flight path angle on the display, the potential flight path angle based at least in part on a measurement of inertial longitudinal acceleration. The potential flight path angle may be indicated by brackets. The potential flight path angle may provide information useful to the pilot in understanding a total energy situation associated with an airplane in flight. The potential flight path angle may be displayed to indicate to a pilot a current magnitude of excess thrust by displaying an indication of both a flight path angle change and/or a change in forward speed.

In another aspect, the invention is directed towards a non-transitory computer readable medium, including instructions for causing a computing environment to perform the above method.

In another aspect, the invention is directed towards a system for displaying vertical flight information, including: a display; a receiving module, for receiving vertical flight data, the vertical flight data including at least a lateral speed, a proximity above terrain, a vertical speed, and a longitudinal acceleration; a determining module, for determining at least a potential flight path angle based on the received data; and a displaying module, for displaying at least the potential flight path angle, where the displaying module is configured to maintain a range having a look ahead duration in time, where the range having a look ahead duration in time is maintained by receiving subsequent vertical flight data and updating the displayed range to reflect the subsequent vertical flight data, while the look ahead duration in time is maintained at a constant value.

Implementations of the invention may include one or more of the following.

The determining module may be further configured for determining a flight path angle based on the vertical speed and the longitudinal speed, and the displaying module may be further configured for displaying the determined flight path angle. The potential flight path angle may be displayed by an acceleration symbol, and the acceleration symbol may be displayed by brackets. The duration may be selected from the group consisting of: 30 seconds, one minute, one and a half minutes, two minutes, or three minutes. The displaying module may be further configured to display a target altitude on the display. The displaying module may be further configured to display a terrain profile under the current flight plan path. The displaying module may be further configured to display a vertical relationship between the airplane vertical position and the runway.

Advantages of certain implementations of the invention may include one or more of the following. Systems and methods according to present principles may provide a convenient graphical display, incorporating integrated functionality, and which may support future FAA flight-path-supported navigation. Other advantages will be understood from the description that follows, including the figures.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 illustrates an example display according to one implementation of systems and methods according to present principles.

FIG. 2 is a flowchart illustrating one method according to an implementation of systems and methods according to present principles.

FIG. 3 illustrates another example display according to an implementation of systems and methods according to present principles.

FIG. 4 illustrates another example display according to an implementation of systems and methods according to present principles.

FIG. 5 illustrates another example display according to an implementation of systems and methods according to present principles.

FIG. 6 is a system diagram illustrating an implementation of a system according to present principles.

Like reference numerals refer to like elements throughout. Elements are not to scale unless otherwise noted.

### DETAILED DESCRIPTION

Systems and methods according to present principles in some implementations provide the pilot with the information necessary to manage the pitch axis of the airplane, e.g., to maintain level flight or perform a controlled ascent or descent, and further provide the pilot with additional information, e.g., a potential flight path angle, to assist in monitoring and managing available energy in a vehicle, e.g., an airplane. Traditionally such information has required separate instruments—the attitude indicator for control, and the vertical speed indicator, the altimeter, and a glideslope or vertical path indicator, for situation feedback. Combining this information in real time is exceptionally difficult and burdensome, particularly for a pilot who may have many other immediate considerations in an average cockpit. Systems and methods according to present principles may be configured to integrate the entire vertical situation into a single display, giving the pilot a more complete picture of what is happening in vertical flight, reducing the mental effort required to gather information from separate instrument and form a mental construct of the integrated situation, computing requirements on other instruments, and providing a more accurate vertical flight picture.

Instruments are sometimes classified as providing control information or situation information. Ideal control information responds instantly and accurately to pilot manipulation of the flight or engine controls. Situation information provides a clear indication of what the airplane is doing but may be delayed in providing that response. Situation information is often influenced by more than pilot manipulation of the controls. In the real world the division between control and situation information is not quite so clear but is still useful. For example:

1. Attitude (pitch and roll) is considered control information.

2. Altitude and heading are situation information.

3. Vertical speed is situation information since it takes several seconds for a change in altitude to develop into a change in static pressure that can be sensed by an instrument or by an air data computer. Quickening the pressure-sensed vertical speed with vertical acceleration (making it instantaneous vertical speed) allows the vertical speed indication to be immediately responsive to pilot pitch control inputs.

4. For a jet engine, N1 or engine pressure ratio (EPR) is considered control information.

5. EGT, exhaust gas temperature, is considered situation information.

One particularly useful aspect of systems and methods according to present principles pertains to the graphic form of the presentation. The VSD provides situation information and is not suitable for control. However, the VFD has the sensitivity and responsiveness to be used for control by the pilot. This sensitivity supports direct control by the pilot based on the VFD information and/or accurate monitoring of the effectiveness of autopilot or a flight director control commands. Sensitivity is achieved by controlling the display distance and display altitude, maintaining an essentially constant duration in time look ahead. That is, to ensure the sensitivity of the VFD remains adequate for the full range of flight conditions the airplane may encounter, the vertical and lateral dimensions of the display area may be continuously adjusted according to the airplane ground speed, vertical speed, and proximity to the ground. The vertical flight information, which can include a flight plan path and a flight path angle and/or potential flight path angle, special use airspace boundaries, as well as other information, may be portrayed on the display, and the display can be configured to maintain a constant look ahead range in time, e.g., portraying what the airplane will encounter over the next 30 seconds, 1 minute, 2 minutes, 3 minutes, and so on. While not absolutely required, a range in time of 2 minutes has been found appropriate in many situations. Maintaining a constant range represented by a time value, e.g., 2 minutes, requires feedback and modification of the range based on the parameters noted above, e.g., airplane ground speed, vertical speed, and proximity to the ground.

Maintaining useful path sensitivity in the face of large speed changes is a particular problem and generally requires inertially quickened path predictions along with high speed processing of vertical navigation data in the vicinity of the flight plan path. Quickening of the vertical speed information is performed to make the flight path angle representation move fast enough for the pilot to control directly based on this information.

This use of maintained sensitivity, e.g., a constant display range as measured in time, where the display range is constantly or nearly-constantly checked and if necessary modified with updated data, along with quickened path predictions, makes it possible to use the VFD as both a control and a situation display for all vertical instrument flight tasks. This improves the pilot's ability to assess the appropriateness and adequacy of vertical control whether flying manually or when using the autopilot.

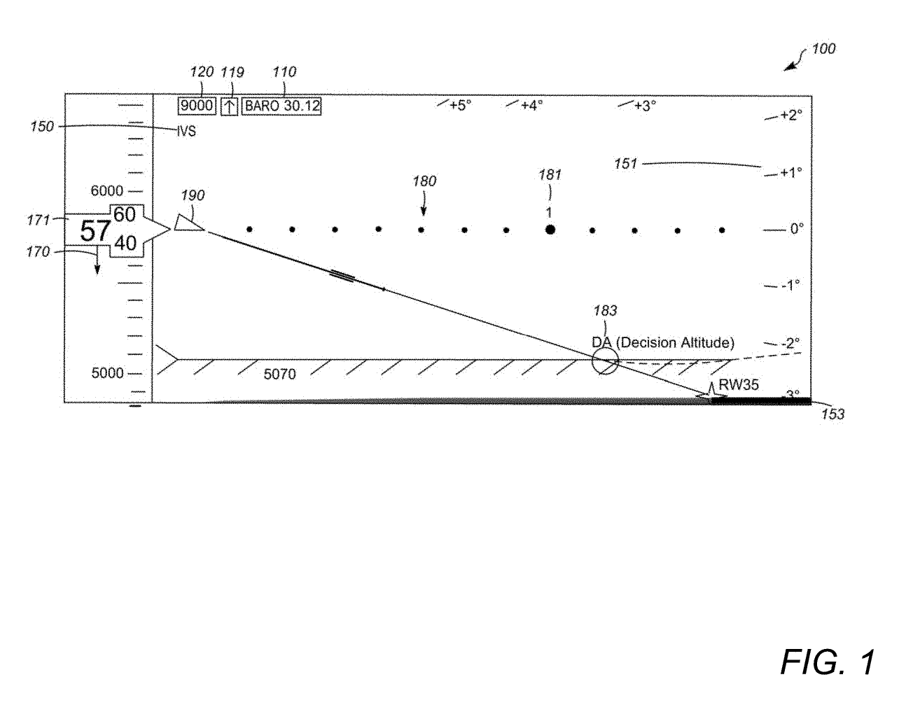

An example display 100 according to the principles of the present invention is illustrated in FIG. 1. Baroset box 110 may be present at all times. The value is in inches of mercury (in of Hg) so long as the airplane altitude is below the transition altitude (TA), otherwise the value is STD. An arrow 119 may be present when the pilot-set Limit Altitude is off screen. The arrow may be up if the Limit Altitude is greater than the Baro Altitude, and the arrow may be down if the Limit Altitude is less than the Baro Altitude. Selected altitude limit box 120 is present when a valid selected altitude exists. The value is the pilot-set Limit Altitude. One of ordinary skill in the art will understand other ways of displaying this information.

The altitude shown at the left end of the VFD is always barometric altitude to comply with the ICAO/FAA standard for the display of altitude. The vertical speed used to generate flight path angle is instantaneous vertical speed (IVS) (barometric vertical speed and vertical inertial acceleration) or on final approach when the vertical path is defined as a GPS angle by instantaneous GPS vertical speed (IGVS) (GPS vertical speed and vertical inertial acceleration). If a failure renders vertical inertial acceleration unavailable, barometric vertical speed is used. The vertical speed label 150 may change depending on the source of the vertical speed information in use.

Vertical speed prediction arrow 170 extends from current altitude line 180 and points to the altitude that will be reached in, e.g., 30 seconds. The vertical speed used to calculate this value is the vertical speed shown in vertical speed value 140. The color of the arrow may normally be white, but may change to another color, e.g., amber, if the airplane height above the terrain beneath the airplane is less than a value based on the current vertical speed value, e.g., if within one minute at the current vertical speed a collision will occur. One of ordinary skill in the art will understand other methods of displaying the vertical speed prediction.

Airplane symbol 190 is located at current altitude line 180, and may rotate around its point in response to the current flight path angle. One of ordinary skill in the art will understand other ways of displaying the current flight path angle. For example, in another implementation, airplane symbol 190 may be replaced by the altitude box 171 as the “own ship” reference, in which case the same will not rotate.

The vertical location of the airplane symbol and the current altitude readout is smoothly adjusted during flight based on the nature of the vertical maneuver underway. For takeoff and climb conditions the location will be low in the display, e.g., in the bottom third. For descent conditions the location will be high in the display, e.g., in the upper third. For level flight conditions the location will be near the middle of the display, e.g., in the middle third. During approach to landing, the airplane position will begin high in the display and will move downward once the landing runway elevation is clearly visible.

As may be seen, the range of the display is measured in minutes, and, e.g., one and one half minutes are shown, with the one-minute mark indicated by reference numeral 181. It is noted in this regard that if the scale were longer, e.g., five or ten minutes instead of one to three minutes, the airplane could not be directly flown with the information, because the sensitivity would not be sufficient. The airplane could be potentially far away from the path before the pilot recognized the airplane was off the path, because the angle of difference is relatively small. In addition to displacement from the path, the pilot has to be able to see the difference between the actual airplane angle and the flight plan angle—i.e., this distance has to be large enough so that the pilot can see it soon enough to perform a corrective maneuver. If the scale is too large, or the vertical scale covers too great a range, then the angle is too small and the pilot cannot visualize or otherwise detect the difference, i.e., they cannot detect that they are off the flight path. Such aspects are particularly important as an airplane changes speed, as in some cases the angles become even smaller and even more undetectable.

As noted above, in contrast to lateral deviations, where an airplane may be “off” the centerline of the path by a fraction of a mile or even several miles without being outside the lateral limits of the path, deviations in altitude are much more dangerous, and it is crucial for the pilot to recognize when the airplane is away from a desired altitude by more than a few feet.

The large difference in required path accuracy for vertical and lateral information results in the need to have significantly different scaling in the lateral and vertical dimensions of the vertical flight display. This means that angles shown in the display are not presented at their real world proportion. The flight path angle 151 scale provides a visual reference for the pilot of the current angular scaling of the display. Flight path information 191 is shown at the correct scaled angle giving the pilot another useful reference for a scaled angle.

In addition, such automatic feedback and control of the display can be contrasted with simply “zooming in” on a vertical situation display. With the effect of airplane speed changes, the dissimilar lateral and vertical scaling, and with the fixed levels at which such changes in scale accomplished by “zooming” are accomplished, simply “zooming in” represents an undesirable option for the pilot as the same is burdensome, requiring constant effort, and indeed not accomplishing the goal of easing cockpit workload.

Referring back to FIG. 1, a decision altitude 183 is shown, which is one of several types of parameters termed “minimums”. The decision altitude is the point at which the pilot either has to have the runway in sight or the pilot has to execute a missed approach. Such decision altitude displays are also a particularly useful feature of systems and methods according to present principles. Generally, such “minimums” data is not digitized, and has to be accurately entered into navigation database. Having such displayed provides a particularly useful and new feature.

Terrain information 153 may also be displayed on the VFD (see FIG. 1). The terrain information depicted on the VFD/VSD is comprised of a continuous line of the highest elevations in each “slice” of terrain along the intended flight plan path or along an extension of the current track angle if no relevant flight plan path exists. The “slices” of terrain data are normal to the flight plan path or track and extend approximately 1.8 times the required path width either side of the flight plan centerline. The shape of the slices depends on the definition of the path centerline. The slices are rectangular when the flight plan centerline is straight and trapezoidal if the centerline is a curve.

The terrain information is displayed for that portion of the displayed range where the terrain elevation is within the altitude range of the display. Once terrain is visible within the lower 15% of the VFD screen height, the airplane position moves downward at the rate of the current vertical speed.

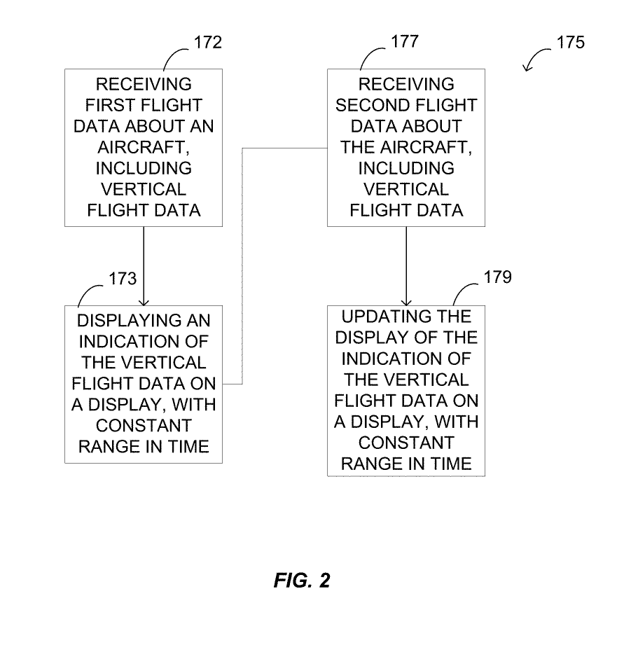

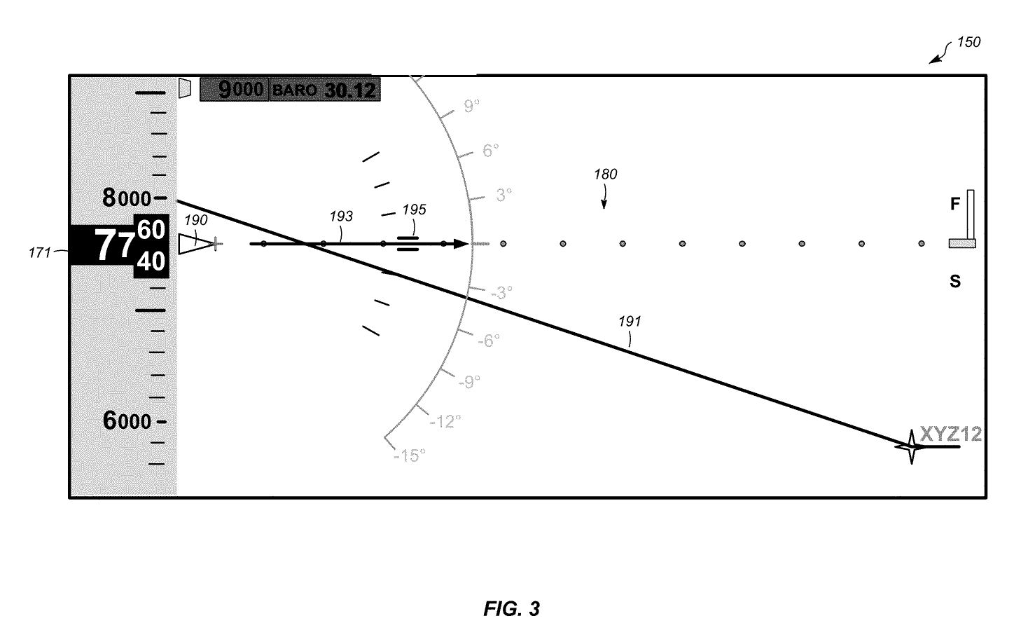

FIG. 2 is a flowchart 175 showing a method according to present principles which may be employed to construct the above interface, e.g., of FIG. 1, as well as of FIG. 3. In a first step, first flight data is received about an airplane, including vertical flight data (step 172). An indication of the vertical flight display is then displayed on a display (step 173). This display is made such that the display covers a constant range in time. For example, a range of the displayed data may be configured to represent a look ahead duration in time, the range extending over an expected distance the airplane will travel in the duration in time. Second flight data is then received about the airplane (step 177). The display is then updated of the indication of the vertical flight data, such that the look ahead duration in time is maintained at a constant value.

In implementations, the first flight data and the second flight data may generally include ground speed, vertical speed, and proximity to the ground. In other implementations, additional data may be incorporated into the calculations, including: vertical flight plan, current altitude, current vertical speed, current longitudinal acceleration, current vertical acceleration, terrain profile beneath flight plan, target altitude value, and a minimum altitude for the current instrument approach procedure.

As noted above providing such information on a display in a way that is useful for control of an airplane requires various steps of “quickening” data that is otherwise not useful or sensitive enough for control. For example, if such data is used for control, it should be such that if a change is made, the result of the change can be immediately seen. For example, the pilot may need to change the pitch, which will change the flight path angle. If it changes enough, no further adjustments are necessary. If it does not, the pilot may need to change the pitch more, and so on, and such adjustments require rapid feedback. In one implementation, quickening is accomplished by an inertial complementary filter. Such quickening avoids sensor artifacts and the like, e.g., because the vertical speed as determined by barometric pressure may be inherently wrong in the short term in some aircraft. Thus, combining barometric pressure readings with inertial sensing, e.g., using AHARS, allows a better and more accurate measure of vertical speed. Such sensing can determine on an extremely accurate basis rates at which an airplane is climbing or descending, and furthermore can do so on a very rapid basis. In this sense the barometric pressure provides a long-term component of instantaneous vertical speed, and inertial sensing provides a short-term component to instantaneous vertical speed, together making a generally acceptable smooth value for this quantity.

FIG. 3 illustrates another exemplary interface of a vertical flight display 150 according to present principles. Elements that are in common with FIG. 1 are not described again, and reference is made to the prior description above. In FIG. 3, a flight plan path 191 is illustrated towards a point XYZ12, and a current flight path angle 193 is shown based on current flight data, e.g., the first or second flight data described above. Brackets 195 are illustrated which provide an indication to the pilot or other operator of potential flight path angle or acceleration, as will be described below.

In this context it is noted that, generally, long term control of the vertical path of any airplane is a matter of coordinating two different controls: flight path angle and thrust (or power). At a constant power setting, a change in the airplane flight path angle will result in a speed change, and vice-versa. In current airplanes, power management is a learned skill unique to the particular airplane type and the airplane-engine characteristics. Pilot experience in that airplane will help the pilot estimate how much power change is necessary in frequently-encountered conditions. That estimate is used to position the power lever(s), and then the pilot waits to see what speed change results. This process is repeated when the desired speed or rate of change in speed is achieved.

Systems and methods according to present principles allow the visualization of flight path angle and the use of the same on a control basis. Immediate feedback may be received on the magnitude of power change required in any circumstance. That is, it is not necessary to wait to see if speed will change (or not) as intended. The result is lower pilot workload for speed management and more accurate tracking of the intended speed for airplanes without an autothrottle or when the pilot wants to manage pitch and power manually.

In more detail, flight path angle is the angle whose tangent is the vertical speed divided by the groundspeed. Pilot control over flight path angle is generally accomplished through adjustments to pitch attitude which causes the flight path angle to change. The display of the flight path angle may be on the display noted above, with the range having a constant look ahead duration in time.

A step of inertial quickening is performed on the vertical speed in order for it to be smooth and accurate enough to be usable. In more detail, flight path angle is based in part on altitude which is generally considered situation information due to the slowness of barometric pressure changes, and thus cannot be used for control. However, the same may be used for control by “quickening” the flight path angle information, where the quickening is based on a quantity such as vertical speed divided by groundspeed, where the vertical speed has been “quickened” as noted above, such as with the use of vertical acceleration information. In some cases, groundspeed may also be “quickened”, although for a current class of airplanes such is generally not required. This allows the pilot to see the ultimate effect of normal pitch inputs on the flight path.

Inputs to the calculation in display of the flight path angle may include in particular longitudinal speed, vertical speed (quickened), as well as, in some cases, other parameters as described below.

It is noted that the terms potential flight path and flight path acceleration refer to the same symbol; the difference being the intended use of the symbol information. This duality is a key characteristic of the pilot's use of symbol 195. For clarity this document uses the term potential flight path but could equally use the other term.

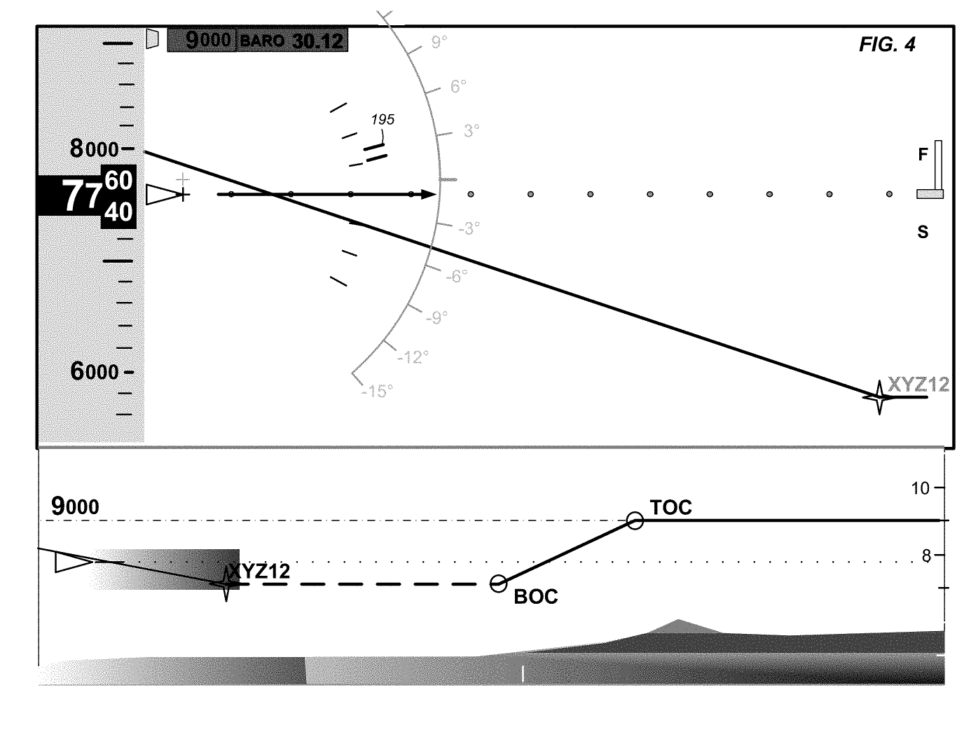

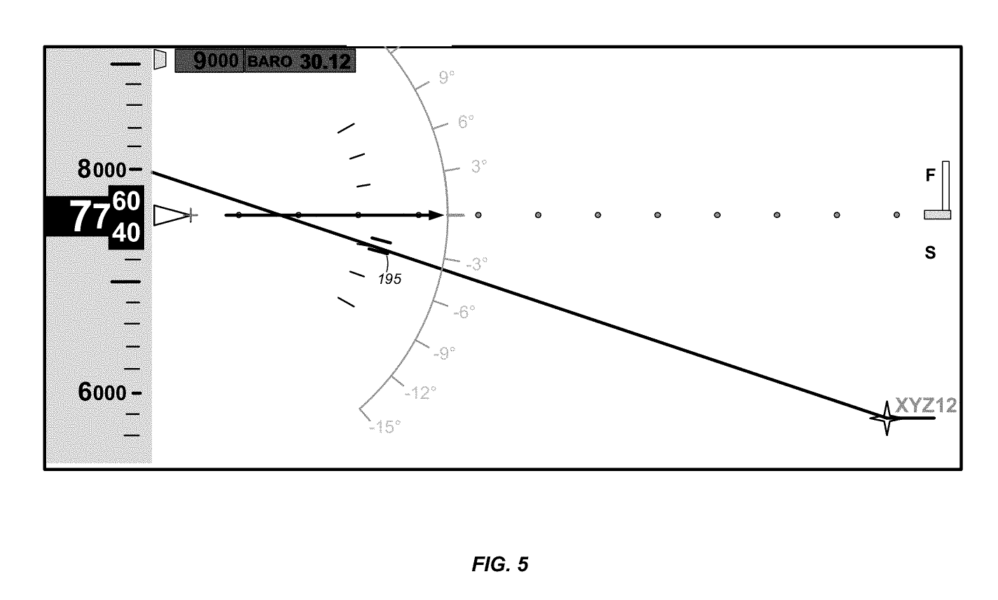

Systems and methods according to present principles may also calculate and display an indication of a potential flight path angle, the same providing a highly useful energy management tool for a pilot. The data can be used to help the pilot understand what the total energy situation is. For example, if the potential flight path symbol brackets the flight path angle, as shown by the bracket 195 in FIG. 3, then the pilot has the right amount of thrust set, i.e., the right amount of energy, to hold whatever the airplane is doing currently. In other words, if the pilot's intent is to fly a constant glide path with no change in current speed, then the pilot should adjust the power setting to ensure the potential flight path symbol 195 overlays the current flight path angle 193. In contrast, if the acceleration symbol is high, if it is above the current flight path angle, then the pilot is adding energy to the airplane, and the airplane will climb or accelerate or perform a combination of both (see FIG. 4, which also illustrates an exemplary terrain display). Put another way, if the pilot's intent is to accelerate while climbing at a fixed power setting, the pilot should adjust the flight path angle to be below the potential flight path symbol. The angular distance between the symbol and the flight path is directly proportional to the acceleration that will occur. If the potential flight path symbol is below the flight path angle, then there is not enough energy to maintain the current situation, and the airplane will either decelerate or descend, depending on what the pilot chooses to do (see FIG. 5).

Systems and methods according to present principles may calculate the potential flight path angle using, e.g., longitudinal acceleration information. The longitudinal acceleration information may come from the AHRS and may be scaled appropriately by a processor in the display system, which provides an immediate indication of a rate of change of speed. Systems and methods according to present principles may convert longitudinal acceleration into the equivalent flight path angle change. By use of such information, the pilot has all the information necessary to manage both pitch and power/thrust/energy for the current vertical flight task.

Systems and methods according to present principles thus provide significant information to a pilot, and further provide information that may be applied to numerous situations. For example the thrust available will vary with altitude. So the amount of energy that is available to climb is not constant over multiple thousands of feet. Without systems and methods according to present principles, the pilot does not have this information, and if the pilot is not monitoring multiple instruments as described above, the pilot may very easily inadvertently decrease speed below a best rate of climb speed (or inadvertently accelerate if the airplane is descending), and may then have to “play catch up” and adjust the power. In contrast, with systems and methods according to present principles, it is immediately apparent what is happening, and the flight path angle may be adjusted to match the available power. For example, if the airplane is climbing, the thrust available at the higher altitude will decrease with altitude, and the acceleration symbol may show the decrease. Using systems and methods according to present principles, the pilot can easily adjust the flight path angle to climb making use of the available thrust at that altitude, because the display adjusts the location of the acceleration symbol brackets to indicate the resultant of the net thrust-minus-drag force on the aircraft, i.e., mass times longitudinal acceleration.

Thrust is generally not known directly. However, from inertial sensing F=ma may be determined in each axis. As a particular example, if the longitudinal acceleration is zero, the net force in the longitudinal direction, thrust minus drag, must be zero. For most airplanes, the pilot doesn't have much control over drag, so his ability to change the net thrust minus drag force in the short term is limited to changes in thrust.

Drag is changed by flaps, landing gear, speed breaks, and airplane speed. The first two are generally on or off and their use is driven by other considerations. Speed breaks could be used for longitudinal force control if the pilot is provided with a suitable control device; however, speed breaks also couple into lift, with the result that the pilot would have to change pitch attitude for every speed break change, entailing a high workload. Airplane speed takes time to change and has a significant impact on range, making the pilot reluctant to depart from the speeds planned for a current phase of flight.

So as a practical matter drag changes are not a reasonable way to control the net thrust minus drag force. Thus, potential flight path angles disclosed here are generally related to thrust control. When a drag change occurs, however, e.g., a landing gear extension, the effect on longitudinal acceleration will be immediately obvious in terms of potential flight path angle. This gives the pilot added insight into how much thrust should be added or removed when the airplane drag situation is changed.

In another example, in a particular maneuver, constant speed may be desired to be maintained, and the location of the brackets may be subsequently calculated to allow the pilot to control for constant speed during maneuvers. For example, the pilot may desire to transition from a level flight to a climb, or from a descent to level flying. It is unfortunately easy to inadvertently delay the thrust, i.e., delay adding or subtracting power, until the vertical maneuver is started. When such an error occurs, the speed will vary depending on if excess or deficient thrust is present. Using systems and methods according to present principles, pitch and power may be adjusted at the same time so as to result in a net zero speed change. Such may be particularly useful in descents, as in such airplanes typically accelerate rapidly, and if power is not removed quickly, the airplane may pick up undesired speed if the pilot is not paying attention. In systems and methods according to present principles, the pilot is enabled to immediately see the effect of their actions, and can pull the power back or add power right away.

The potential flight path scale indicates to the pilot how much angular change or acceleration is available for those situations where the 195 symbol is not aligned with flight path angle. Each tick mark represents 3° of angle change or an acceleration of 1 knot per second. This scale is referenced to the current flight path angle and therefore rotates with changes in flight path angle.

Inputs to the vertical flight display may include one or more of the following: true airspeed; ground speed; vertical speed; current altitude; current position over the ground; the flight plan/flight plan path, i.e., the path in space desired to be followed; calculated airplane performance; terrain along, and to either side of, the lateral flight plan path; the location of the departure and destination airports; obstacle clearance climb constraints in the vicinity of an airport; and the minimums associated with any instrument approach procedure in the flight plan. Generally, the accelerations measured are longitudinal, lateral, and vertical. Vertical acceleration is used to perform steps within the quickening process to develop the flight path angle. Longitudinal acceleration is used in the calculation of the potential flight path angle. Inertial sensing may be used to sense acceleration in these three axes.

Additional variations of systems and methods according to present principles are now described.

Airplane flight path angle is also subject to oscillation at the frequency of the phugoid (long term) mode of the airplane pitch axis. By “quickening” the displayed flight path angle with quickened vertical speed data, most of the oscillation due to the phugoid may be removed from the display and the flight path angle data made responsive enough for the pilot to use as a control reference. The phugoid is a normal characteristic of the response to a pitch disturbance in all airplanes. The phugoid is lightly damped and therefore takes several cycles to decay. The phugoid period varies with the airplane type and the flight conditions. For many airplanes, the phugoid period is between 15 and 25 seconds.

While many instrument flight tasks call for constant speed, others require acceleration. The potential flight path angle symbol is useful in such cases, since it will be immediately apparent that the thrust is sufficient for both a climb and acceleration when potential flight path angle (the brackets) is above the current flight path angle. Conversely, descents that include a requirement to decelerate can be very demanding since it may not be possible to satisfy both objectives with a change in thrust alone. If reducing thrust does not achieve a potential flight path angle that is less than the required descent angle, the pilot knows immediately that additional drag must be deployed or that speed must be reduced before the descent is initiated.

As noted above, in order to maintain sufficient sensitivity for the VFD information, the display range may be kept short (three minutes or less to the edge of the screen.) A vertical situation display may be placed immediately below the VFD to give the pilot a longer range view of the vertical flight path. Its range may be the same as the HSD range. To help the pilot use both of the displays, the area covered by the VFD may be shaded differently than that of the rest of the VSD background.

In other variations, it is noted that some vertical flight tasks are defined by reference to the ground, other tasks are defined by reference to the local air mass. For example, in one implementation, barometric related vertical data is employed for tasks associated with air traffic control. On the other hand, GPS vertical data is employed for the final approach, where the path is defined with respect to the ground, so the vertical component of flight path angle is instantaneous GPS vertical speed to match. Aspects such as flight path angle and flight path acceleration indications may be calculated and displayed appropriately for these different tasks, depending on implementation. Similarly, the angle of the flight plan path may be calculated to be consistent with established vertical constraints and the climb or descent capability of the airplane.

In another variation, a vertical flight plan is defined along a lateral plan that is constructed of straight segments connected by curved segments of various dimensions. The solution displayed on the VFD may be computed along the lateral path, ensuring that the vertical tasks are displayed without geometric distortion. If the pilot has not entered a lateral path, or chooses to fly off the lateral path, the solution displayed on the VFD may be computed along an extension of the current track angle.

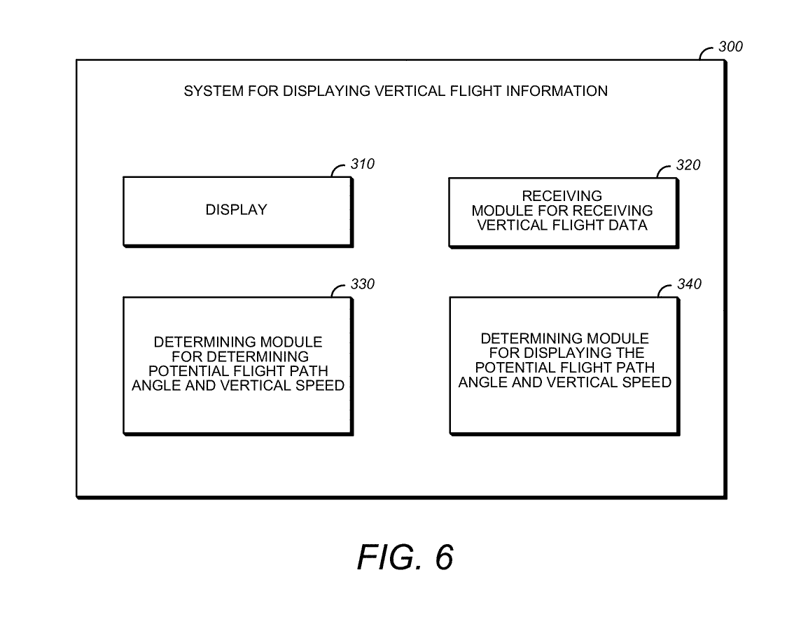

FIG. 6 illustrates a system 300 according to an embodiment of the invention. System 300 includes display 310 that displays vertical flight data. System 300 also includes receiving module 320 that receives information about the vertical flight situation, e.g., first flight data, second flight data, and so on. The receiving module 320 may receive such data in various ways, e.g., via input ports which may be wired or wireless, and so on. The information generally includes input data as described above, e.g., true airspeed; ground speed; vertical speed; current altitude; current position over the ground; the flight plan/flight plan path, i.e., the path in space desired to be followed; calculated airplane performance; terrain along, and to either side of, the lateral flight plan path; the location of the departure and destination airports; obstacle clearance climb constraints in the vicinity of either airport; and the minimums associated with any instrument approach procedure in the flight plan. Determining module 330 calculates, among other things, a flight path angle, a flight plan path, and a potential flight path angle, e.g., the potential flight path symbol or brackets, described above. Displaying module 340 takes the calculated potential flight path angle and other calculated values/results and renders them in a graphical fashion on display 310. This illustrates merely one possible configuration of system modules, and one of ordinary skill in the art will recognize various other possible configurations of a system according to the present principle. Other system components may also be included.

The system and method may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, are loaded into random access memory. Inputs to the application, e.g., from the plurality of users or from any one user, may be by any number of appropriate computer input devices. For example, users may employ a keyboard, mouse, touchscreen, joystick, trackpad, other pointing device, or any other such computer input device to input data relevant to the calculations. Data may also be input by way of an inserted memory chip, hard drive, flash drives, flash memory, optical media, magnetic media, or any other type of file-storing medium. The outputs may be delivered to a user by way of a video graphics card or integrated graphics chipset coupled to a display that maybe seen by a user. Given this teaching, any number of other tangible outputs will also be understood to be contemplated by the invention. It should also be noted that the invention may be implemented on any number of different types of computing devices, e.g., personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. The application may download over the mobile connection, or over the WiFi or other wireless network connection. The application may then be run by the user. Such a networked system may provide a suitable computing environment for an implementation in which a plurality of users provide separate inputs to the system and method. In the above system where avionics controls and information systems are contemplated, the plural inputs may allow plural users to input relevant data at the same time.

The above description discloses various embodiments of the invention, however, the scope of the invention is to be limited only by the claims appended hereto, and equivalents thereof.

1. A method for displaying vertical flight information, comprising:
a. receiving first flight data about an airplane, including vertical flight data; and
b. displaying an indication of the vertical flight data on a display, wherein a range of the displayed data is configured to represent a look ahead duration in time, the range extending over an expected distance the airplane will travel in the duration in time;
c. receiving second flight data about the airplane;
d. updating the displayed indication of the vertical flight data on the display, the updating such that the look ahead duration in time is maintained at a constant value.

2. The method of claim 1, wherein the first flight data and the second flight data include ground speed, vertical speed, and proximity to the ground.

3. The method of claim 2, wherein the first flight data and the second flight data further include one or more selected from the group consisting of: vertical flight plan, current altitude, current vertical speed, current longitudinal acceleration, current vertical acceleration, terrain profile beneath flight plan, target altitude value, runway elevation, and a minimum altitude for the current instrument approach procedure.

4. The method of claim 1, wherein the displaying is performed with sufficient sensitivity such that a pilot is enabled to control the vertical flight of an airplane with the displayed data.

5. The method of claim 4, wherein the displaying is such that direct manipulation of the pitch and power controls is supported.

6. The method of claim 1, wherein the duration is selected from the group consisting of: 30 seconds, one minute, two minutes, or three minutes.

7. The method of claim 1, further comprising displaying a flight path angle on the display, the flight path angle based on quickened vertical speed and ground speed.

8. The method of claim 1, further comprising displaying an indication of a potential flight path angle on the display, the potential flight path angle based at least in part on a measurement of inertial longitudinal acceleration.

9. The method of claim 8, wherein the potential flight path angle is indicated by brackets.

10. The method of claim 8, wherein the potential flight path angle provides information useful to the pilot in understanding a total energy situation associated with an airplane in flight.

11. The method of claim 8, wherein the potential flight path angle is displayed to indicate a current magnitude of excess thrust by displaying an indication of both a flight path angle change and/or a change in forward speed.

12. A non-transitory computer readable medium, comprising instructions for causing a computing environment to perform the method of claim 1.

13. A system for displaying vertical flight information, comprising:
a. a display;
b. a receiving module, for receiving vertical flight data, the vertical flight data including at least a lateral speed, a proximity above terrain, a vertical speed, and a longitudinal acceleration;
c. a determining module, for determining at least a potential flight path angle based on the received data; and
d. a displaying module, for displaying at least the potential flight path angle, wherein the displaying module is configured to maintain a range having a look ahead duration in time, wherein the range having a look ahead duration in time is maintained by receiving subsequent vertical flight data and updating the displayed range to reflect the subsequent vertical flight data, while the look ahead duration in time is maintained at a constant value.

14. The system of claim 13, wherein the determining module is further configured for determining a flight path angle based on the vertical speed and the longitudinal speed, and wherein the displaying module is further configured for displaying the determined flight path angle.

15. The system of claim 13, wherein the potential flight path angle is displayed by an acceleration symbol, and wherein the acceleration symbol is displayed by brackets.

16. The system of claim 13, wherein the duration is selected from the group consisting of: 30 seconds, one minute, two minutes, or three minutes.

17. The system of claim 13, wherein the displaying module is further configured to display a target altitude on the display.

18. The system of claim 13, wherein the displaying module is further configured to display a terrain profile under the current flight plan path.

19. The system of claim 13, wherein the displaying module is further configured to display a vertical relationship between the airplane vertical position and the runway.
